(19) United States
(12) Patent Application Publication
(10) Pub. No.: US 2004/0103625 A1
(43) Pub. Date: Jun. 3, 2004

(54) Air blower apparatus for use in inspection apparatus and inspection apparatus housing with the air blower apparatus

(75) Inventors: Norio Nakano, Hyogo (JP); Eiji Ishimoto, Hyogo (JP); Yusuke Fujitani, Yamanashi (JP)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: AGILENT TECHNOLOGIES, INC.

(21) Appl. No.: 10/712,489

(22) Filed: Nov. 13, 2003

(30) Foreign Application Priority Data
Nov. 29, 2002 (JP) 2002-347967

(51) Int. Cl. B01D 46/00

(52) U.S. Cl. 55/385.2; 55/385.6

(57) ABSTRACT

An air blower apparatus for use in an inspection apparatus includes an air blowing device for blowing air via an air filter to a recording medium and a recording apparatus. The air blowing device includes a fan unit provided above the recording medium, and a fan unit housing provided above the fan unit. The fan unit housing includes a first buffer space having an inlet port directed substantially downwardly toward the recording medium, and the first buffer space temporarily accumulates air inhaled from the inlet port. The fan unit inhales air from the inlet port that faces the first buffer space, discharges inhaled air at a substantially constant air flow rate to deliver the air via an air filter from an outlet port to the recording medium by a fan, and the discharged air is reflected on the recording medium and returns to the inlet port.

### BACKGROUND OF THE INVENTION

1. Field of the Invention

The present invention relates to an air blower apparatus for use in an inspection apparatus for a recording medium and a recording apparatus. In particular, the present invention relates to an air blower apparatus including an air blowing device for blowing air via an air filter to not only a recording medium, such as a hard disk of a hard disk drive unit or the like, but also a recording apparatus for recording data on the recording medium, as well as an inspection apparatus housing provided with the air blower.

2. Description of the Related Art

For example, in an inspection apparatus for a recording apparatus, such as a hard disk drive unit or the like, a recording medium, such as a hard disk or the like, is covered with a cover, and the cover is opened in only a small area for a measuring part or the whole apparatus is covered with a cover, in order to reduce the influence of variation in ambient temperature and winds. This conventional inspection apparatus is disclosed in, for example, U.S. Pat. No. 6,229,304.

When the recording medium is covered with the cover that is opened in only the small area for the measuring part, the cover located around the recording medium imposes limits on the measuring range of the recording medium. Moreover, the cover cannot completely keep out of external temperatures and winds having unstable directions, and this leads to variation in results of the measurement. Further, in the case where the whole apparatus is covered with the cover, there is the following problem. The heat generated by a spindle, a motor or the like causes a difference in temperature between an internal area within the cover of the measuring apparatus and outside air, and the temperature within the cover thereof is disordered by the opening and closing of a door upon replacing the heads, causing winds that disadvantageously lead to variation in the results of the measurement.

Recently, hard disk manufacturers have increased the recording densities of recording media in accordance with an increase in the recording capacity of the hard disk drive unit. In accordance with this, it has been required to provide a glass recording medium of a high surface precision in order to keep the flying height of a magnetic head stable. It is a well-known fact that the glass-recording medium is easy to break as compared with an aluminum recording medium and that flying broken glass is dangerous. The cover opened in only the small area for the measuring part is not used for the measurement by means of the glass-recording medium in consideration of safety. When the whole apparatus is covered with the cover, the spindle is stopped upon the replacement of the magnetic head in order to improve safety. When the spindle is stopped, heat generated by the acceleration of the spindle causes a change in temperature of the recording medium and its surroundings, and this causes a factor for deteriorating the precision.

In order to solve the above-mentioned problems, Japanese Patent Laid-Open Publication No. 2002-208133 discloses an inspection apparatus housing described as follows. There is disclosed a housing for enclosing a measuring apparatus for use in a hard disk recording medium and a recording apparatus for recording data on the recording medium. A fan is provided with a high efficiency particulate air filter and blows air onto the hard disk recording medium and the recording apparatus under the measurement via the high efficiency particulate air filter at substantially constant air temperature and at a substantially constant air flow rate. Moreover, an automatic door is provided in a position where the door does not project into an air protection area that includes the positions of the hard disk recording medium and the recording apparatus under the measurement and their predetermined surrounding areas, and the automatic door shields the other area from the air protection area in the housing for enclosing the measuring apparatus when the measurement does not take place.

However, in the apparatus disclosed in the Japanese Patent Laid-Open Publication No. 2002-208133, the whole device is covered with the cover, and accordingly, there is disadvantageously generated a temperature difference between the inside of the cover and the outside air due to the heat generation of a spindle, a motor and so on. When there is no fan, the air within the cover is drawn in from above the recording medium toward the center of the recording medium by the recording medium that is rotating with the spindle and discharged in the horizontal direction of the recording medium. By the rotation of the recording medium, the above-mentioned airflow is generated. Since the fan takes in or inhales the outside air as it is and since the temperature of this outside air is lower than the temperature of the air disposed within the cover, this air temperature disadvantageously causes a temperature variation within the cover. Because substantial air tightness is achieved by the cover, an air flow resistance limits the air flow rate of the fan, and this becomes a factor for scarce air reaching the magnetic head and the recording medium. Since the air blown by the fan is weak, and the flow of air generated by the rotation of the recording medium is strong, a mixture of cold air from the fan and warm air from within the cover on the recording medium disadvantageously produces an unstable state. Moreover, such a temperature change of a cassette and a magnetic head during frequent replacement of an old magnetic head for a new magnetic head causes a temperature drift due to this temperature differential which occurs between the inside and outside of the cover.

### SUMMARY OF THE INVENTION

The present invention solves the above-mentioned problems and provides an air blower apparatus for use in an inspection apparatus capable of maintaining a uniform temperature distribution in the vicinity of the recording medium and blowing air at a uniform air flow rate.

The present invention further provides an inspection apparatus housing provided with the above-mentioned air blower apparatus.

According to one aspect of the present invention, there is provided an air blower apparatus for use in an inspection apparatus. The air blower apparatus includes an air blowing device for blowing air via an air filter to a recording medium being measured and to a recording apparatus for recording data on the recording medium. The air blowing device includes a fan unit and a fan unit housing. The fan unit is provided above the recording medium, and the fan unit housing is provided above the fan unit. The fan unit housing includes a first buffer space having an inlet port directed substantially downwardly toward the recording medium. The first buffer space temporarily accumulates air inhaled from the inlet port.

In the above-mentioned air blower apparatus, the fan unit inhales air from the inlet port that faces the first buffer space, discharges inhaled air at a substantially constant air flow rate to deliver the air via an air filter from an outlet port to the recording medium by means of a fan, and the discharged air is reflected on the recording medium and returns to the inlet port. This leads to not only formation of a circulation path of a flow of air, the flow of air flowing from the first buffer space via the inlet port, the fan, the air filter, the outlet port, the recording medium and the inlet port and returning to the first buffer space, but also inhaling of outside air from the inlet port. This allows for the temperature distribution in the vicinity of the recording medium to remain substantially constant.

The above-mentioned air blower apparatus preferably further includes a second buffer space provided between the fan and the air filter and within the fan unit. The second buffer space temporarily accumulates the air discharged from the fan so as to provide a high pressure state.

In the above-mentioned air blower apparatus, the fan is preferably a blower type fan, which blows and discharges air from the inlet port substantially in a horizontal direction. Otherwise, the air filter is preferably a high efficiency particulate air filter.

The above-mentioned air blower apparatus preferably further includes a panel provided at at least one place on a side of the recording medium, the panel preventing outside air from flowing directly to the recording medium.

In the above-mentioned air blower apparatus, the recording medium is a hard disk recording medium, and the recording apparatus includes a magnetic head.

According to another aspect of the present invention, there is provided an inspection apparatus housing which includes the above-mentioned air blower apparatus for use in the inspection apparatus, and the recording apparatus for recording data on the recording medium.

### BRIEF DESCRIPTION OF THE DRAWINGS

These and other objects and features of the present invention will become clear from the following description taken in conjunction with the preferred embodiments thereof with reference to the accompanying drawings throughout which like parts are designated by like reference numerals, and in which:

FIG. 1 is a perspective view showing an inspection apparatus housing 100 for use in a recording apparatus, when viewed from the front thereof, according to a preferred embodiment of the present invention;

FIG. 2 is a perspective view showing a magnetic head, a cassette, a head loading mechanism and their peripherals of the recording apparatus of FIG. 1;

FIG. 3 is a perspective view of the inspection apparatus housing when a panel is opened upward in the inspection apparatus housing of FIG. 1;

FIG. 4 is a perspective view of the inspection apparatus housing of FIG. 1 when two surfaces located on the front side are closed with panels;

FIG. 5 is a perspective view of a fan unit provided with a HEPA filter of FIG. 1, when viewed from the top thereof;

FIG. 6 is a perspective view of the fan unit provided with the HEPA filter of FIG. 1, when viewed from the bottom;

FIG. 7A is a top view of the fan unit provided with the HEPA filter of FIGS. 5 and 6;

FIG. 7B is a cross-sectional view taken along a line A-A′ of FIG. 7A;

FIG. 8 is a schematic view of a longitudinal section showing a flow of air in the vicinity of the fan unit provided with the HEPA filter and a hard disk recording medium in the inspection apparatus housing of FIG. 1 according to the preferred embodiment;

FIG. 9 is a schematic view of the longitudinal section showing a flow of air in the vicinity of the fan unit provided with the HEPA filter and a hard disk recording medium in the inspection apparatus housing of FIG. 1 according to a modified preferred embodiment;

FIG. 10 is a schematic view showing a configuration of an outlet port located on the bottom surface of the fan unit provided with the HEPA filter according to a preferred embodiment and measurable areas of the recording apparatus;

FIG. 11 is a schematic view showing a configuration of an outlet port located on the bottom surface of the fan unit provided with the HEPA filter according to a first modified preferred embodiment and a track traced by a magnetic head due to the movement of a Y stage when the magnetic head has a skew angle of 30 degrees;

FIG. 12 is a schematic view showing a configuration of the outlet port located on the bottom surface of the fan unit provided with the HEPA filter according to the first modified preferred embodiment and a track traced by the magnetic head 1 due to the movement of the Y stage when the magnetic head has a skew angle of −30 degrees; and

FIG. 13 is a schematic view showing a configuration of an outlet port located on the bottom surface of the fan unit provided with the HEPA filter according to a second modified preferred embodiment and a measurable area of the recording apparatus.

### DETAILED DESCRIPTION OF THE PREFERRED EMBODIMENTS

Preferred embodiments of the present invention will be described below with reference to the drawings.

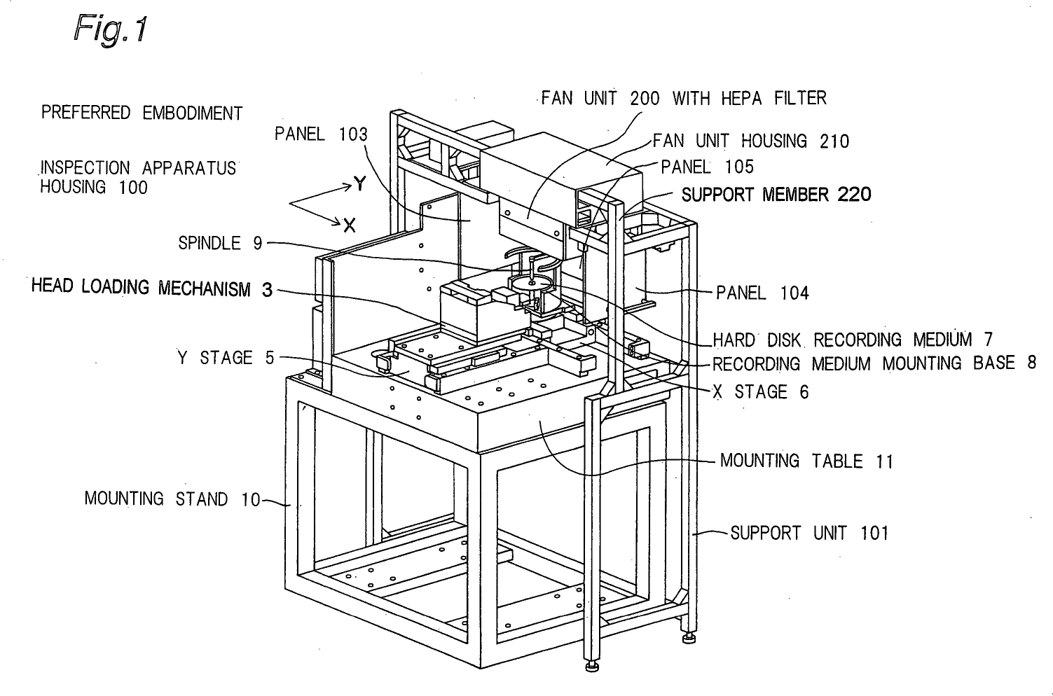

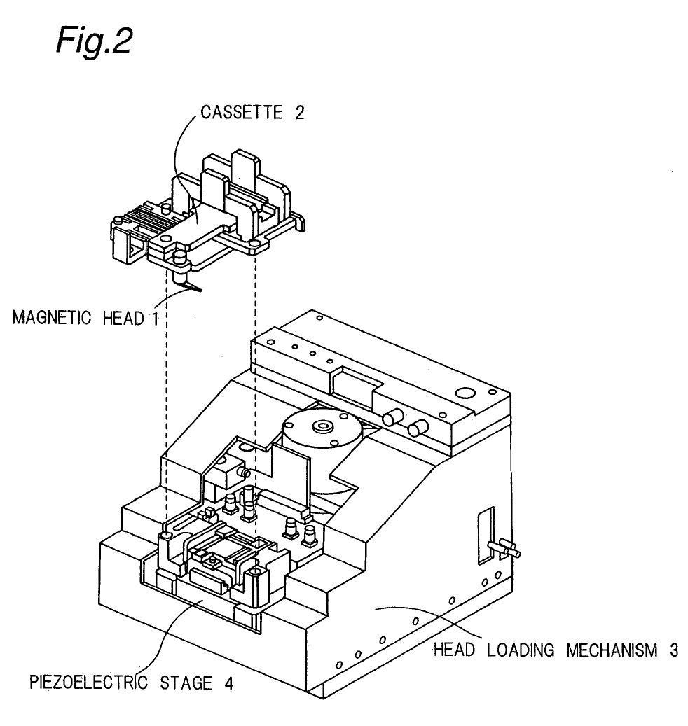

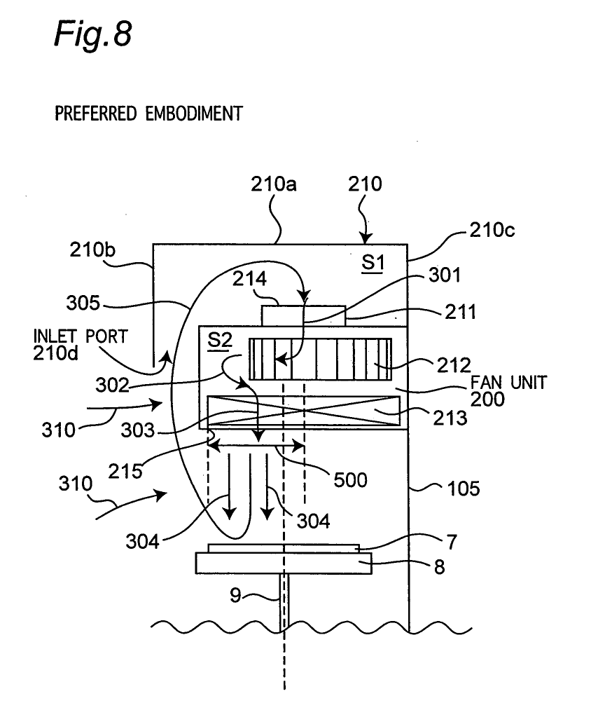

FIG. 1 is a perspective view of an inspection apparatus housing 100 for a recording apparatus, when viewed from the front thereof, according to a preferred embodiment of the present invention. FIG. 2 is a perspective view showing a magnetic head 1, a cassette 2, a head loading mechanism (hereinafter referred to as an HLM) 3 and its peripherals of the recording apparatus of FIG. 1. FIG. 8 is a schematic view of the longitudinal section showing a flow of air in the vicinity of the fan unit 200 provided with a HEPA filter and a hard disk recording medium 7 in the inspection apparatus housing 100 of FIG. 1.

Referring to FIG. 1, the inspection apparatus housing 100 according to the present preferred embodiment is provided as a housing of an inspection apparatus for a recording medium for the inspection of the performance of the magnetic head by writing a measurement signal from the magnetic head 1 on a hard disk recording medium 7 mounted on a mounting base 8 and thereafter reading the written measurement signal for the measurement of the intensity of the signal, write track width and so on. As shown in FIGS. 1 and 8, this inspection apparatus housing 100 includes the following:

(a) a fan unit 200 provided with the HEPA filter above the hard disk recording medium 7; and

(b) a fan unit housing 210, which is provided above the fan unit 200 and substantially includes an inlet port 210d (See FIG. 8) only in its lower portion directed to the hard disk recording medium 7 and a buffer space S1 formed for temporarily accumulating air inhaled from the inlet port 210d.

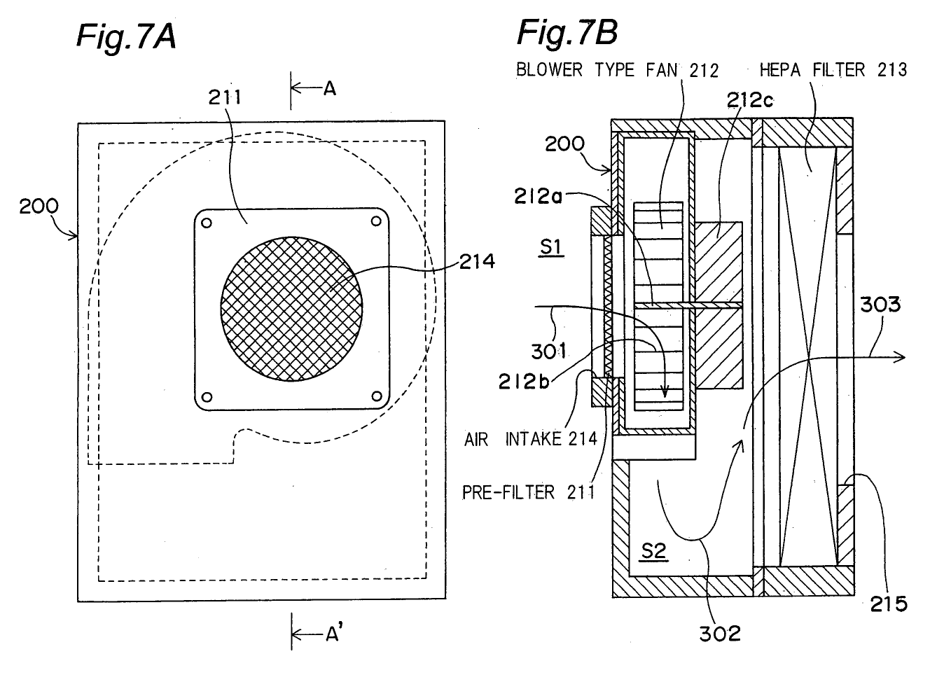

In this case, the fan unit 200 inhales air from an air intake 214 that faces the buffer space S1, and the inhaled air is discharged by a blower type fan 212 from an outlet port 215 via a HEPA filter 213 toward the hard disk recording medium 7 at a substantially constant flow rate. The discharged air is reflected on the top surface of the hard disk recording medium 7 and returns to the inlet port 210d. By thus forming a circulation path 305 of the flow of air, which flows from the buffer space S1 via the air intake 214, the blower type fan 212, the HEPA filter 213, the outlet port 215, the hard disk recording medium 7 and the inlet port 210d and returns to the buffer space S1, and by inhaling outside air from the inlet port 210d, a temperature distribution in the vicinity of the hard disk recording medium 7 is maintained to be substantially constant. Moreover, as shown in FIGS. 7B and 8, by further forming a buffer space S2, which is provided between the blower type fan 212 and the HEPA filter 213 inside of the fan unit 200 and provides a high pressure state by temporarily accumulating the air discharged from the blower type fan 212, air can be sent at a substantially uniform wind velocity, and the temperature distribution in the vicinity of the hard disk recording medium 7 can be maintained to be substantially more constant.

In the present specification, the high efficiency particulate air filter is typically a generic name for an air filter capable of removing various particles of sub-micron size with efficiency as high as 99.9% or more, and the high efficiency particulate air filters include air filters, which are commercially available and popularly known as an ULPA filter, also inclusive of the HEPA filter 213 employed in the present preferred embodiment. In the present specification hereinbelow, the description is given with reference to the HEPA filter 213 since this filter gives a full understanding of the present invention, unless it is otherwise specified. The HEPA filter 213 is the abbreviation of High Efficiency Particulate Air Filter, which has been developed by NASA of U.S.A. in 1950's. This HEPA filter 213 is a filter that has the performance of removing all sorts of fine particles with an efficiency of 99.97% or more, no matter what dust, pollen or bacillus, so long as the particle has a size of not smaller than 0.3 microns. The filter, which has been manufactured from cellulose asbestos in the early stage of development, is currently produced from glass wool and used by folding a filter material of a paper-like shape.

Referring to FIG. 1, a mounting table 11 is placed and fixed on a mounting stand 10, and the following inspection apparatus is provided on the mounting table 1 1. As shown in the detail view of FIG. 2, a magnetic head 1, which is an object to be measured, is fixed to a jig 2 called a cassette (hereinafter referred to as a cassette) 2 by an urging force applied from an elastic body such as a spring or the like, and the cassette 2 is placed in a predetermined position on an HLM 3 by an operator. By a Y stage 5 that is moved in the Y direction and an X stage 6 that is moved in the X direction perpendicular to the Y direction, the cassette 2 is moved to a portion, which belongs to the hard disk recording medium 7 and is desired to be measured, and then, the measurement is started. At this time, the hard disk recording medium 7 is placed on the recording medium mounting base 8, and is rotated by a spindle 9, while the magnetic head 1 is positioned with very high precision by a piezoelectric stage 4.

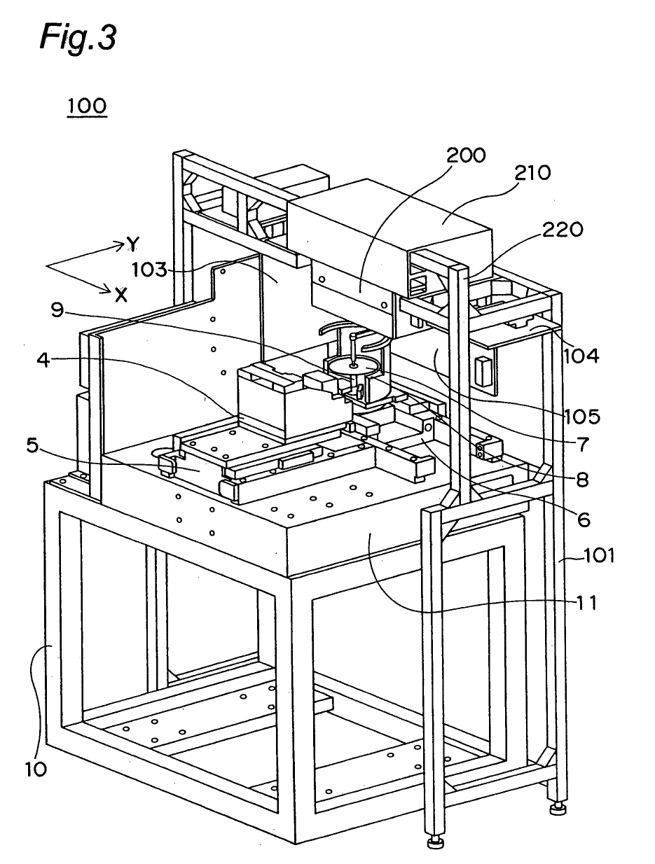

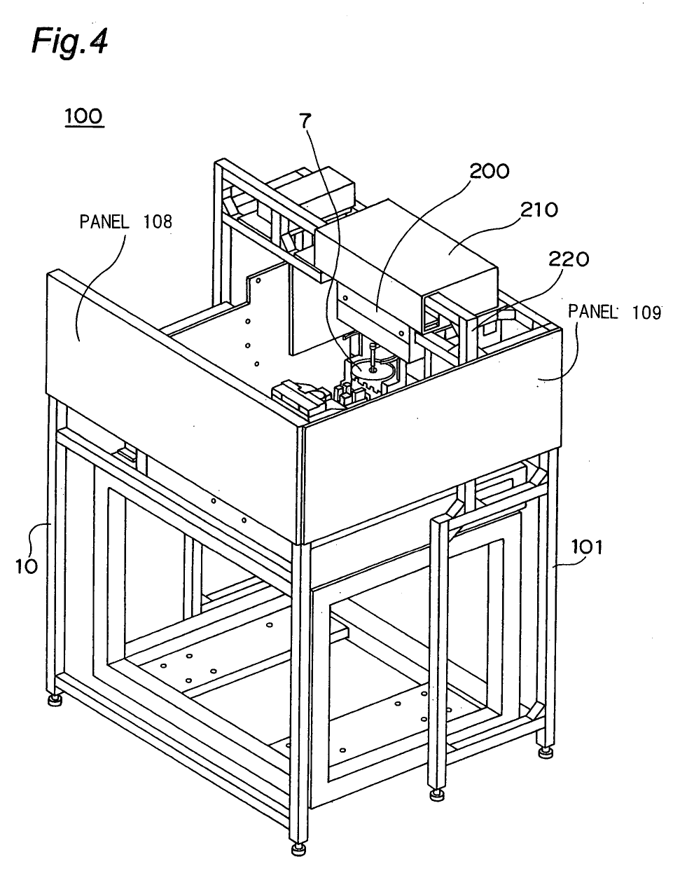

The fan unit 200 provided with the HEPA filter, which will be described in detail later, is supported so as to be positioned just above the hard disk recording medium 7 by a support member 220 joined with an upper portion of a support unit 101. Moreover, panels 103, 104 and 105 for shielding the outside air located on three side surfaces that surround the hard disk recording medium 7 are provided along the outside surfaces of the inspection apparatus housing 100 in order to prevent the outside air from flowing directly toward the hard disk recording medium 7. In this case, as shown in FIG. 3, the panel 104 is capable of opening and closing so as to open upward in order to facilitate the replacement of the hard disk recording medium 7. Further, in order to prevent the outside air from directly flowing toward the hard disk recording medium 7 and prevent the hard disk recording medium 7 from scattering toward the measurer when the recording medium is broken and scattered during the measurement, panels 108 and 109 may be provided on the two side surfaces located on the front side surrounding the hard disk recording medium 7 as shown in FIG. 4.

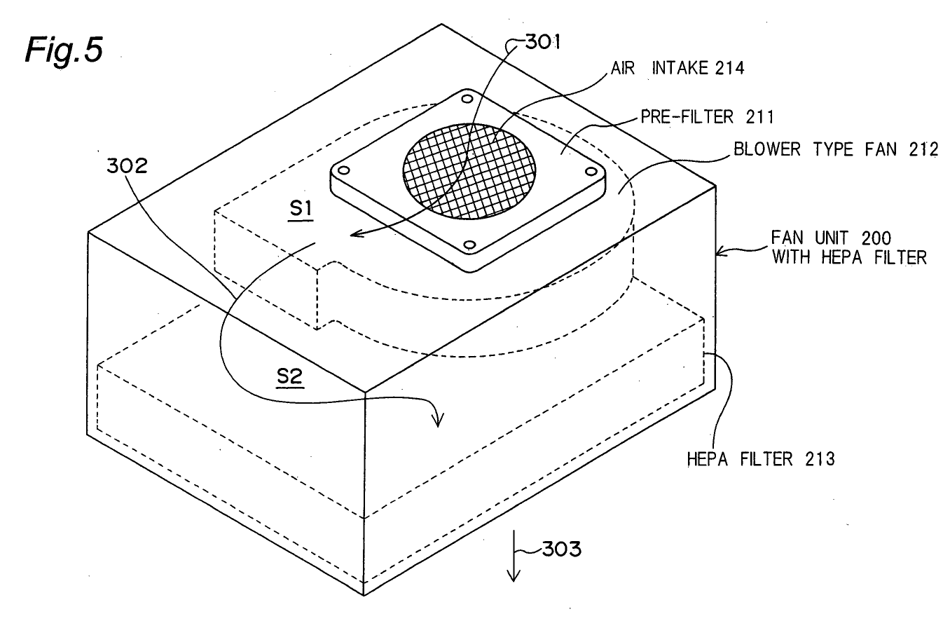

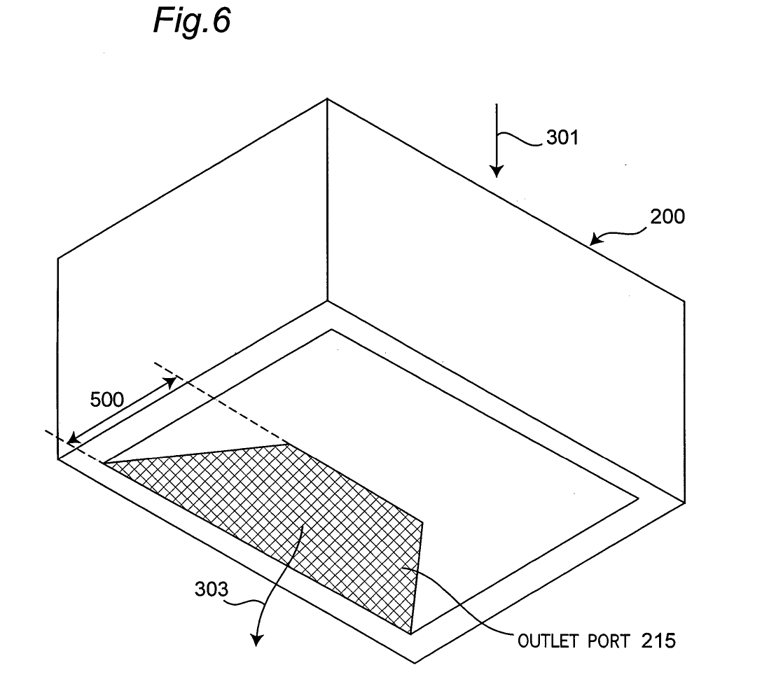

FIG. 5 is a perspective view of the fan unit 200 provided with the HEPA filter of FIG. 1, when viewed from the top thereof. FIG. 6 is a perspective view of the fan unit 200 provided with the HEPA filter of FIG. 1, when viewed from the bottom thereof. FIG. 7A is a top view of the fan unit 200 provided with the HEPA filter of FIGS. 5 and 6, and FIG. 7B is a cross-sectional view taken along the line A-A′ of FIG. 7A. A structure of the fan unit 200 provided with the HEPA filter will be described in detail below with reference to these figures.

Referring to FIGS. 5, 7A and 7B, a pre-filter 211 having a circular air intake 214 is provided so as to oppose to the buffer space S1 on the top surface of the fan unit 200, and a blower type fan 212 is provided just below the pre-filter. In this case, the reason why the blower type fan 212 is used is that the pulsation of the blown air can be prevented and the air velocity can be made substantially more constant in comparison with the case where the so-called axial flow type fan unit is employed. Moreover, a wire type mesh for protection is provided for the air intake 214. The blower type fan 212 is rotated around a shaft 212a that extends in the vertical direction, and the fan is constructed of a plurality of blower vanes 212b which are provided so as to be parallel to the shaft 212a. The blower vanes 212b are rotated by a motor 212c, air inhaled from the air intake 214 via the pre-filter 211 as indicated by the arrow 301 is sent to the buffer space S2 in the horizontal direction (frontward to the left in FIG. 5) as indicated by the arrow 302. Then, the blown air is temporarily accumulated in the buffer space S2 so as to provide a state of higher pressure in the buffer space S2, which is sealed up except for the air intake 214 and the outlet port 215, within the fan unit 200. Subsequently, as indicated by the arrow 303, air is discharged via the HEPA filter 213 from the outlet port 215 of a trapezoidal shape as shown in FIG. 6. By this operation, preferably, air can be blown and discharged at a substantially constant air flow rate at a wind or air velocity of 0.5 m/sec to 2 m/sec. The configuration of the outlet port 215 will be described in detail later. As shown in FIGS. 6 and 7, the outlet port 215 is narrowed and reduced to a span 500, which is narrower than the output port of the HEPA filter 213 and contributes to the provision of an increased increase in the buffer space S2. Further, a wire type mesh for protection is provided for the outlet port 215.

FIG. 8 shows a flow of air in the vicinity of the fan unit 200 provided with the HEPA filter and the hard disk recording medium 7 in the inspection apparatus housing 100 of FIG. 1. Referring to FIG. 8, the buffer space S1 formed above the fan unit 200 defines a space enclosed by an top surface 210a and side surfaces 210b and 210c of the fan unit housing 210 and two side surfaces (which cannot be shown) which is provided so as to be parallel to the plane of the sheet of FIG. 8 except for the rectangular inlet port 210d formed downwardly toward the top surface of the hard disk recording medium 7. Moreover, a distance from the outlet port 215 of the fan unit 200 to the top surface of the hard disk recording medium 7 should be preferably as short as possible so that the wind velocity of air to be blown is not weakened. For example, the distance should be set preferably within a range of 20 mm to 400 mm and more preferably set within a range of 100 mm to 300 mm. It is to be noted that the panel 105 for shielding outside air is joined with the lower side of the surface 210c of the fan unit housing 210 and is extended to a side of the hard disk recording medium 7. Moreover, in order to maintain the flow of air in the circulation path 305 as much as possible in the inspection apparatus housing 100, the replacement work area of the hard disk recording medium 7 should have a necessary minimum regional area, preferably.

In the fan unit 200 constructed as above, as indicated by the arrow 301 of FIG. 8, air is inhaled from the air intake 214 that faces the buffer space S1, and then, as indicated by the arrow 302, the inhaled air is blown and discharged via the buffer space S2 to the HEPA filter 213 by means of the blower type fan 212. At this time, the buffer space S2 temporarily accumulates the air discharged from the blower type fan 212 so as to provide a high pressure state, and the air in the buffer space S2 is blown and discharged at a substantially constant air flow rate via the HEPA filter 213 from the outlet port 215 to the hard disk recording medium 7 as indicated by the arrow 303. The discharged air is delivered to the top surface of the hard disk recording medium 7 and is thereafter reflected on the top surface to return to the inlet port 210d. As described above, there is formed the circulation path 305 of the flow of air, which flows from the buffer space S1 via the air intake 214, the blower type fan 212, the buffer space S2, the HEPA filter 213, the outlet port 215, the hard disk recording medium 7 and the inlet port 210d and returns to the buffer space S1. In this case, the air discharged from the outlet port 215 does not wholly returns to the inlet port 210d, and it is presumed that part or, for example, 60 percent or more of the air discharged from outlet port 215 will return. On the other hand, the outside air 310 is inhaled into the inlet port 210d together with the flow of air in this circulation path 305.

In the flow of air in the circulation path 305, the temperature of the air rises especially in the fan unit 200, and it is preferable to take in or inhale a certain amount of outside air 310 from the inlet port 210d so as to cancel this. That is, by taking in a certain amount of outside air 310, which has a temperature lower than that of the air in the circulation path 305, in addition to the circulation path 305 of the flow of air, the temperature of the air, which is circulated and thereafter delivered to the hard disk recording medium 7, is made substantially constant. Since the air is in the circulation path 305 in the vicinity of the top surface of the hard disk recording medium 7, a temperature distribution in the vicinity of the hard disk recording medium 7 (in detail, a temperature distribution concerning the horizontal position of the top surface of the hard disk recording medium 7) can be made substantially constant. Moreover, by virtue of the formation of the circulation path 305 of the flow of air, the wind velocity can be made more uniform in comparison with the prior art.

Furthermore, it is more preferable to adjust and form the amount of air taken in from the inlet port 210d by adjusting the aperture area of the inlet port 210d depending on the environment in which the inspection apparatus housing 100 is installed. It is to be noted that, if the aperture area of the inlet port 210d is made excessively small, then the amount of circulation of air in the circulation path 305 is reduced to debase the effect of maintaining the temperature to be constant. Therefore, it is considered that attention is required to be paid.

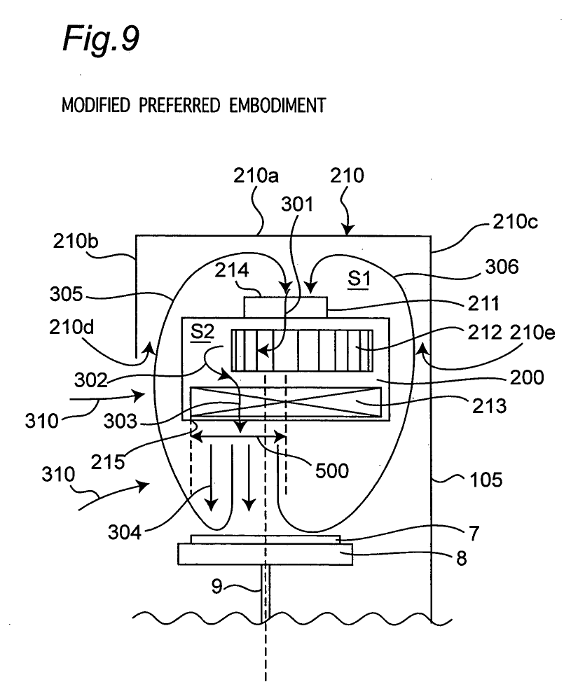

FIG. 9 is a schematic view of the longitudinal section showing a flow of air in the vicinity of the fan unit 200 provided with the HEPA filter and the hard disk recording medium 7 in the inspection apparatus housing 100 according to a modified preferred embodiment.

Referring to FIG. 9, the present apparatus is characterized in that another inlet port 210e is provided between the fan unit 200 and a side surface 210c of the apparatus housing 210 so as to form two air circulation paths 305 and 306. With this arrangement, a ratio of return of the air discharged from the outlet port 215 to the inlet port 210d can be made higher than that of the preferred embodiment of FIG. 8, and the amount of the total flow of air through the circulation paths 305 and 306 can be increased. This makes the temperature of the air delivered to the hard disk recording medium 7 substantially more constant, and this leads to allowing the temperature distribution in the vicinity of the hard disk recording medium 7 to be made substantially more constant.

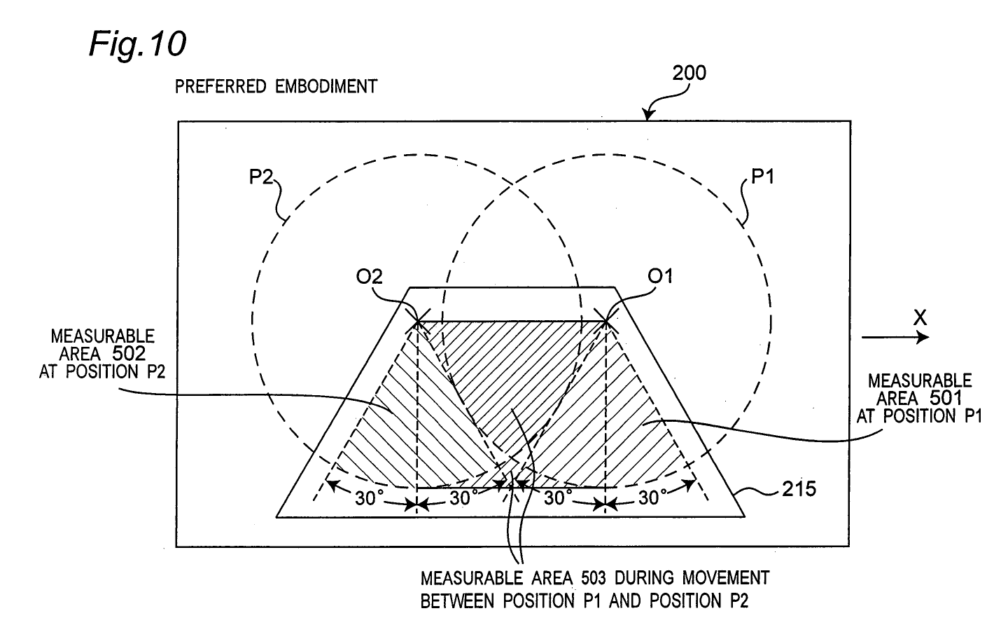

FIG. 10 is a schematic view showing a configuration of the outlet port 215 located on the bottom surface of the fan unit 200 provided with the HEPA filter according to a preferred embodiment. In FIG. 10, P1 and P2 imaginarily illustrate the positions of both the mounting end portions of the hard disk recording medium 7 that is moved in the X direction by the X stage 6 just below the fan unit 200 by projecting the positions on the bottom surface of the fan unit 200.

Referring to FIG. 10, the hard disk recording medium 7 is moved from the position P1 to the position P2, and the electric recording and reproducing characteristics of the hard disk recording medium 7 are measured. In the position P1 of the hard disk recording medium 7, the hard disk recording medium 7 is rotated around an axis of a center O1, and the measurement is performed by moving the magnetic head 1 in the radial direction toward the circumference. For example, when the magnetic head 1 is moved within a skew angle range of ±30 degrees, the measurable area of the recording apparatus in the position P1 becomes a sectorial region denoted by the reference numeral 501. Moreover, in the position P2 of the hard disk recording medium 7, the hard disk recording medium 7 is rotated around an axis of a center O2, and the measurement is performed by moving the magnetic head 1 in the radial direction toward the circumference. For example, when the magnetic head 1 is moved within a skew angle range of ±30 degrees, the measurable area of the recording apparatus in the position P2 becomes a sectorial region denoted by the reference numeral 502. Furthermore, the total measurable area of the recording apparatus when the hard disk recording medium 7 is moved from the position P1 to the position P2 by the movement of the X stage 6 in the X direction becomes a region obtained by adding an area 503 to the areas 501 and 502. The reason why the outlet port 215 is formed to have the trapezoidal configuration in the present preferred embodiment is that winds of substantially constant temperature and wind velocity is to be delivered to the entire measurable area on the hard disk recording medium 7 in the positions P1 and P2 and in a middle positions located between the positions P1 and P2. As described above, the velocity of the wind discharged from the fan unit 200 increases when the configuration of the outlet port is formed so that the air delivery range is limited to the measurement area, and therefore, the blower type fan 212 can be efficiently operated. Moreover, the influence of a crosswind that passes through the neighborhood of the recording medium 7 on the results of the measurement can be reduced.

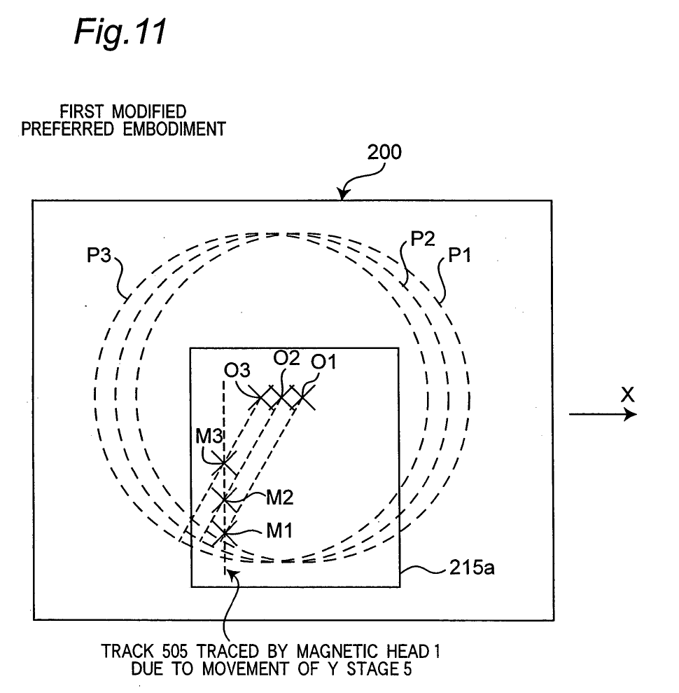

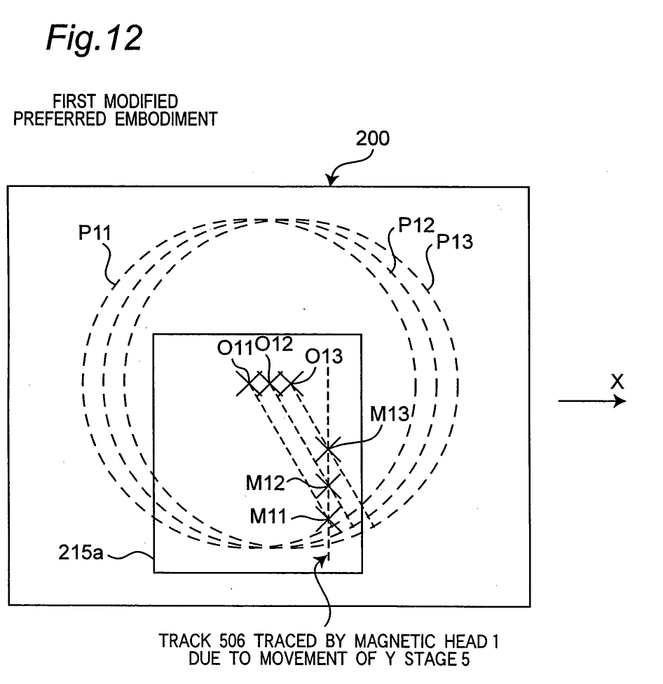

FIG. 11 is a schematic view showing a configuration of an outlet port 215a located on the bottom surface of the fan unit 200 provided with the HEPA filter according to the first modified preferred embodiment and a track 505 traced by the magnetic head 1 due to the movement of the Y stage 5 when the magnetic head 1 has a skew angle of 30 degrees. FIG. 12 is a schematic view showing a configuration of the outlet port 215a located on the bottom surface of the fan unit 200 provided with the HEPA filter according to the first modified preferred embodiment and a track 506 traced by the magnetic head 1 due to the movement of the Y stage 5 when the magnetic head 1 has a skew angle of −30 degrees.

In FIG. 11, P1, P2 and P3 imaginarily illustrate the positions of three mounting portions of the hard disk recording medium 7 when the recording medium is moved in the Y direction by the Y stage 5 just below the fan unit 200 by projecting the positions on the bottom surface of the fan unit 200. When the hard disk recording medium 7 is moved from the position P1 via the position P2 to the position P3, the center thereof is also moved from O1 via O2 to O3, and the measurement points in this case are indicated by M1, M2 and M3. Therefore, the track traced by the magnetic head 1 due to the movement of the Y stage 5 becomes a straight line denoted by the reference numeral 505. Moreover, in FIG. 12, P11, P12 and P13 imaginarily illustrate the positions of three mounting portions of the hard disk recording medium 7 when the recording medium is moved in the Y direction by the Y stage 5 just below the fan unit 200 by projecting the positions on the bottom surface of the fan unit 200. When the hard disk recording medium 7 is moved from the position P11 via the position P12 to the position P13, the center thereof is also moved from O11 via O12 to O13, and the measurement points in this case are indicated by M11, M12 and M13. Therefore, the track traced by the magnetic head 1 due to the movement of the Y stage 5 becomes a straight line denoted by the reference numeral 506. In the present first modified preferred embodiment, there is provided the outlet port 215a having the rectangular configuration in order to cover the whole area of the measurement points when the magnetic head 1 is moved by the movement of the X stage 6 and the Y stage 5. This arrangement can be used for blowing air with a limitation toward the actual measurement area.

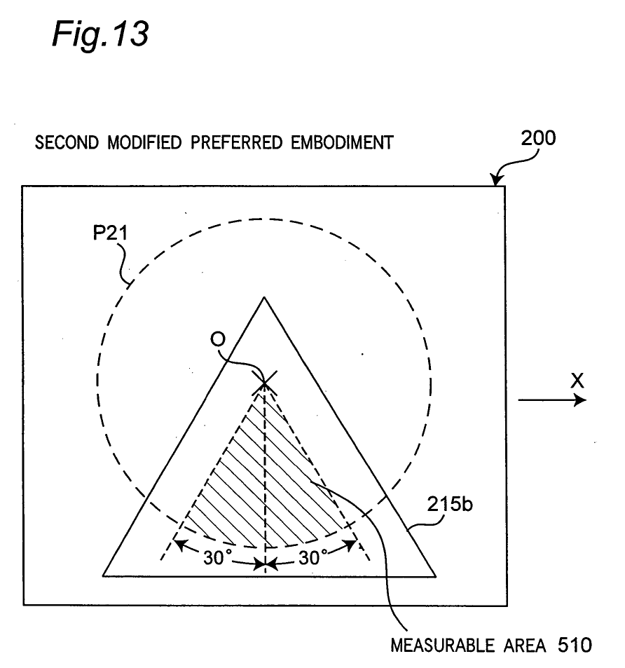

FIG. 13 is a schematic view showing a configuration of an outlet port 215b located on the bottom surface of the fan unit 200 provided with the HEPA filter according to a second modified preferred embodiment and a measurable area 510 of a recording apparatus. According to the second modified preferred embodiment, which is the case of a spin stand apparatus of the type such that the hard disk recording medium 7 is not moved. The measurement area of the recording apparatus can be further limited than the preferred embodiment and the first modified preferred embodiment. When magnetic head 1 has a skew angle of ±30 degrees, the measurable area 510 becomes a sectorial shape as shown in FIG. 13. Therefore, the outlet port 215b is formed into a triangular configuration.

The present inventor and others measured the track profile characteristic of the hard disk recording medium 7 when the measurement of the hard disk recording medium 7 was performed by means of the inspection apparatus housing 100. According to the results of the measurement, it was confirmed that the variation in the track profile characteristic was remarkably reduced.

As a factor for aggravating the environment, there can be considered the influence of outside air ascribed to an ion generator, an air conditioner or the like as placed in the vicinity of the inspection apparatus housing 100. According to the inspection apparatus housing 100 of the present preferred embodiment, air is inhaled by the fan unit 200 from the air intake 214 that faces the buffer space S1, the inhaled air is delivered and discharged at a substantially constant air flow rate via the HEPA filter 213 from the outlet port 215 to the hard disk recording medium 7 by means of the blower type fan 212, and the discharged air is reflected on the top surface of the hard disk recording medium 7 to return to the inlet port 210d. This leads to formation of the circulation path 305 of the flow of air, which flows from the buffer space S1 via the air intake 214, the blower type fan 212, the HEPA filter 213, the outlet port 215, the hard disk recording medium 7 and the inlet port 210d and returns to the buffer space S1. In addition, since the outside air is inhaled from the inlet port 210d, the temperature distribution in the vicinity of the hard disk recording medium 7 can be maintained to be substantially constant. Moreover, by further forming the buffer space S2, which is provided between the blower type fan 212 and the HEPA filter 213 within the fan unit 200 and temporarily accumulates the air discharged from the blower type fan 212 so as to provide a high pressure state, air can be blown with a substantially uniform wind velocity, and the temperature distribution in the vicinity of the hard disk recording medium 7 can be maintained to be substantially more constant.

By virtue of the above-mentioned arrangement and operation of the above-mentioned preferred embodiments, the following particular advantageous effects can be further obtained.

(1) It is possible to achieve the measurement in a more stable environment within the inspection apparatus housing 100, and the variations in the results of the measurement of the hard disk recording medium 7 can be further reduced in comparison with conventions systems. That is, the ambient temperature, the temperature distribution and the air or wind environment of the hard disk recording medium 7 and the magnetic head 1 that writes the measurement signal or data on the recording medium can be maintained to be constant, and stable results of the measurement can be obtained.

(2) Since the hard disk recording medium 7 can be kept rotated, the influence of the expansion and contraction of the hard disk due to the temperature change as caused when the spindle rotation is changed can be substantially reduced.

(3) The operating life of the amplifier of an electric circuit for writing and reading the measurement signal on the hard disk recording medium 7 and the motor of the spindle 9 can be increased.

(4) Since air is consistently blown, the motor of the spindle 9 can be consistently rotated, and the measurement can be performed without concern for the start-up speed of the motor of the spindle 9.

As described above, according to the air blower apparatus for use in the inspection apparatus, the air blower apparatus includes an air blowing device for blowing air via an air filter to a recording medium being measured and to a recording apparatus for recording data on the recording medium. The air blowing device includes a fun unit and a fan unit housing. The fan unit is provided above the recording medium, and the fan unit housing is provided above the fan unit. The fan unit housing includes a first buffer space having an inlet port directed substantially downwardly toward the recording medium. The first buffer space temporarily accumulates air inhaled from the inlet port.

In the above-mentioned air blower apparatus, the fan unit inhales air from the inlet port that faces the first buffer space, discharges inhaled air at a substantially constant air flow rate to deliver the air via an air filter from an outlet port to the recording medium by means of a fan, and the discharged air is reflected on the recording medium and returns to the inlet port. This leads to not only formation of a circulation path of a flow of air, the flow of air flowing from the first buffer space via the inlet port, the fan, the air filter, the outlet port, the recording medium and the inlet port and returning to the first buffer space, but also inhaling of outside air from the inlet port. This allows a temperature distribution in the vicinity of the recording medium to be maintained to be substantially constant.

Accordingly, with this arrangement, it is possible to achieve the measurement in a more stable environment in the inspection apparatus housing, and the variations in the results of the measurement of the hard disk recording medium 7 can be further reduced in comparison with the prior art.

Moreover, the above-mentioned air blower apparatus for use in an inspection apparatus is further provided with a second buffer space, which is provided between the fan and the air filter and within the fan unit. The second buffer space temporarily accumulates the air discharged from the fan so as to provide a high pressure state. Therefore, air can be blown at a substantially uniform wind velocity, and the temperature distribution in the vicinity of the recording medium is maintained to be substantially more constant.

Furthermore, in the above-mentioned air blower apparatus for use in the inspection apparatus, the fan is a blower type fan, which blows and discharges air from the inlet port substantially in the horizontal direction. Therefore, the pulsation of the blown air can be prevented, and the air or wind velocity can be made more constant in comparison with the case where the so-called the axial-flow type fan unit is employed.

Furthermore, in the above-mentioned air blower apparatus for use in the inspection apparatus, the outlet port has a configuration such that the air is blown with a limitation toward the actual measurement area. Therefore, winds of which the temperature and the wind velocity are substantially constant can be efficiently delivered. Moreover, the adverse effect on the results of the measurement can be reduced.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An air blower apparatus for use in an inspection apparatus, said air blower apparatus comprising an air blowing device for blowing air via an air filter to a recording medium being measured and to a recording apparatus for recording data on the recording medium,
wherein said air blowing device comprises:
(a) a fan unit provided above said recording medium; and
(b) a fan unit housing provided above said fan unit, said fan unit housing including a first buffer space having an inlet port directed substantially downwardly toward said recording medium, said first buffer space temporarily accumulating air inhaled from said inlet port,
wherein said fan unit inhales air from said inlet port that faces said first buffer space, discharges inhaled air at a substantially constant air flow rate to deliver the air via an air filter from an outlet port to said recording medium by means of a fan, and the discharged air is deflected onto said recording medium and returns to said inlet port, thereby not only forming a circulation path of a flow of air, the flow of air flowing from said first buffer space via said inlet port, said fan, said air filter, said outlet port, said recording medium and said inlet port and returning to said first buffer space, but also inhaling outside air from said inlet port, whereby a temperature distribution in the vicinity of said recording medium is maintained substantially constant.

2. The air blower apparatus as claimed in claim 1, further comprising a second buffer space provided between said fan and said air filter and within said fan unit, said second buffer space temporarily accumulating the air discharged from said fan so as to provide a high pressure state.

3. The air blower apparatus as claimed in claim 1,
wherein said fan is a blower type fan, which blows and discharges air from said inlet port substantially in a horizontal direction.

4. The air blower apparatus as claimed in claim 1,
wherein said air filter is a high efficiency particulate air filter.

5. The air blower apparatus as claimed in claim 1, further comprising a panel provided at at least one place on a side of said recording medium, said panel preventing outside air from flowing directly to said recording medium.

6. The air blower apparatus as claimed in claim 1,
wherein said recording medium is a hard disk recording medium, and
wherein said recording apparatus includes a magnetic head.

7. An inspection apparatus housing comprising:
an air blower apparatus for use in an inspection apparatus; and
a recording apparatus for recording data on said recording medium,
wherein said air blower apparatus comprises an air blowing device for blowing air via an air filter to a recording medium being measured and to said recording apparatus,
wherein said air blowing device comprises:
(a) a fan unit provided above said recording medium; and
(b) a fan unit housing provided above said fan unit, said fan unit housing including a first buffer space having an inlet port directed substantially downwardly toward said recording medium, said first buffer space temporarily accumulating air inhaled from said inlet port,
wherein said fan unit inhales air from said inlet port that faces said first buffer space, discharges inhaled air at a substantially constant air flow rate to deliver the air via an air filter from an outlet port to said recording medium by means of a fan, and the discharged air is reflected on said recording medium and returns to said inlet port, thereby not only forming a circulation path of a flow of air, the flow of air flowing from said first buffer space via said inlet port, said fan, said air filter, said outlet port, said recording medium and said inlet port and returning to said first buffer space, but also inhaling outside air from said inlet port, whereby a temperature distribution in the vicinity of said recording medium is maintained to be substantially constant.

8. The inspection apparatus housing as claimed in claim 7,
wherein said fan unit further comprises a second buffer space provided between said fan and said air filter and within said fan unit, said second buffer space temporarily accumulating the air discharged from said fan so as to provide a high pressure state.

9. The inspection apparatus housing as claimed in claim 7,
wherein said fan is a blower type fan, which blows and discharges air from said inlet port substantially in a horizontal direction.

10. The inspection apparatus housing as claimed in claim 7,
wherein said air filter is a high efficiency particulate air filter.

11. The inspection apparatus housing as claimed in claim 7, further comprising a panel provided at at least one place on a side of said recording medium, said panel preventing outside air from flowing directly to said recording medium.

12. The inspection apparatus housing as claimed in claim 7,
wherein said recording medium is a hard disk recording medium, and
wherein said recording apparatus includes a magnetic head.
